(19) United States
(12) Patent Application Publication
(10) Pub. No.: US 2006/0027463 A1
(43) Pub. Date: Feb. 9, 2006

(54) Water treatment apparatus utilizing ozonation and electrolytic chlorination

(75) Inventors: Dennis Lavelle, Paso Robles, CA (US); Allen D. Clawson, Mapleton, UT (US); Bill Ehrgott, Arroyo Grande, CA (US); Trevor Leger, San Luis Obispo, CA (US); Michael Lee Fraim, Corralas, NM (US)

Correspondence Address: STOUT, UXA, BUYAN & MULLINS LLP, 4 VENTURE, SUITE 300, IRVINE, CA, 92618, US

(73) Assignee: Del Industries, Inc., San Luis Obispo, CA (US)

(21) Appl. No.: 11/166,797

(22) Filed: Jun. 23, 2005

Related U.S. Application Data
(60) Provisional application No. 60/582,258, filed on Jun. 23, 2004.

(51) Int. Cl. C02F 1/461; C25D 17/00

(52) U.S. Cl. 205/556; 205/701; 205/752; 204/277

(57) ABSTRACT

Apparatus for sanitizing water generally includes a line for receiving a flow of water and an injector assembly for introducing an ozone containing gas into the flow of water to produce a first ozonated water having an increased oxygen concentration relative to the flow of water being passed to the injector assembly. The apparatus further includes an electrolytic device, for example, an electrolytic chlorinator cell, positioned to receive the first ozonated water from the injector assembly. The electrolytic device is effective to produce, from the first ozonated water, a second ozonated water including one or more biocidally effective substances other than oxygen gas. The second ozonated water includes biocidally effective substances, for example chlorine, hydroxyl radicals, and/or other effective oxidizing substances. The injector assembly and the electrolytic device are coupled together in a manner such that the first ozonated water is passed substantially directly into the electrolytic device in order to maintain the increased oxygen concentration of the first ozonated water.

### RELATED APPLICATION

This application claims the benefit of U.S. Provisional Patent Application No. 60/582,258, filed Jun. 23, 2004, the entire disclosure of which is incorporated herein by this specific reference.

### BACKGROUND OF THE INVENTION

The present invention relates to water treatment systems and, more particularly, to systems and methods for maintaining the water quality of swimming pools, ponds, aquatic mammal tanks, spas, fountains, cooling towers and the like.

Water quality can be defined by measuring the concentrations of oxidant, total hardness, total dissolved solids, total dissolved organics, and turbidity of the water.

Swimming pools, spas, water features such as ornamental fountains and the like are commonly sanitized using either electrolytic chlorination with/without an ultraviolet light clarifier, or ozonation. Each of these technologies has its own distinct advantages and disadvantages.

Conventional apparatus used to sanitize water in pools and the like, includes electrolytic chlorination systems, or “salt” chlorination systems. These systems utilize an electrolytic cell or “Chlor-alkali” cell, typically comprising a submerged positively charged anode, a negatively charged cathode, and an electrical energy source for applying a current across the gap between the anode and cathode. The anode compartment contains an anolyte including a source of chlorides which, when oxidized, forms chlorine gas. Typically, the chloride source comprises an alkali metal chloride salt such as sodium chloride or potassium chloride, although other sources, such as hydrochloric acid and the like may also be used.

When current is applied across the anode and cathode gap, the sodium and chloride ions disassociate with chloride ion concentrating in the anolyte solution and the sodium ion concentrating in the catholyte solution. Chlorine gas is generated on the anode surface and hydrogen gas is generated on the cathode surface which is released back into the flowing water. The dissolved chlorine gas reacts with the water to create hydrochloric acid (HCl) and hypochlorous acid (HOCl). At concentrations greater than 1 ppm, hypochlorous acid minimizes or prevents the growth of algae, bacteria, and other microorganisms. When an electrolytic cell is used, the sodium hydroxide and hypochlorous acid recombine to form sodium hypochlorite (bleach) which is the active oxidizer transported back into the main body of water to prevent microorganism growth. Typical examples of salt chlorination systems are disclosed in Kosarek, U.S. Pat. No. 4,361,471, Wreath, et al., U.S. Pat. No. 4,613,415, and Lynn, et al., U.S. Pat. No. 5,362,368, the entire disclosures of which are incorporated herein by this reference.

One shortcoming of the electrolytic cell is that calcium carbonate scale and bio-film build up on the cathode side of the mono- or bi-polar cells with time. The carbonate ion is created from the oxidation of organic matter with the chlorine sanitizer and it combines with the calcium ion in the water to make calcium carbonate salt. Current electrolytic cell technology reverses the polarity to switch the anode and cathode surfaces on the bipolar plate to dissolve the calcium carbonate scale build up on the alternate side of the plate. Turbulent flow of saltwater washes the flakes of calcium carbonate off the plate surface and transports the flakes into the main body of water, which can become a visible blemish to clean water.

Another maintenance problem with electrolytic chlorination systems is that bio-film, organic fibers such as hair and pieces of thread and particles such as pieces of leaves or dirt do not dissolve or oxidize with a mild acid solution created on the anode surface. The particles or fibers continue to collect between the plates or on the upstream plate edge of the plate until it reduces the flow of saltwater, then the slot plugs with calcium carbonate scale fortified with organic matter. At this point, the cell will require manual cleaning in addition to acid washing. If a sufficient number of slots plug before the cell is manually cleaned with acid, the cell will shut down or an area on one or more the plates will exceed the current rating of 1.2 amp-per-square-inches. At 1.2 amps-per-square-inches, the hydrogen production will delaminate the protective oxide coating off the current cathode surface of the bi-polar plate. The removal of the protective oxide coating will cause plate failure when the polarity is switched back to anode.

Another shortcoming of electrolytic chlorination systems is that amines, such as ammonia, tend to build up in the water over time, binding with the chloride to form chloramines. Since chloramines have strong odors, can irritate the skin and eyes of bathers, are toxic to ingest, cause discoloration and fading of human hair and bathing suits, it is recommended that pool and spa owners periodically superchlorinate or “shock” the water by adding high amounts of chlorine. The increased chlorine breaks down the chloramines by oxidizing the amines to nitrogen gas. Unfortunately, the amount of chlorine required for superchlorination is higher than is safe for swimming or bathing, thus rendering the pool unusable for an extended period.

Another recommended option for removing chloramines, chlorinated methanes, and bacteria residue from commercial pools and the like is to install an ultraviolet (UV) clarifier upstream of the electrolytic chlorination system. The clarifier uses a low pressure mercury lamp contained in a quartz sleeve to treat the saltwater flowing through the cell. The 254 nm radiation produced from mercury lamp decomposes the chloramines into hydrochloric acid and nitrogen gas and the 185 nm radiation decomposes the methyl chloride to hydrochloric acid and formaldehyde. The UV radiation also damages the microbial DNA of bacteria and algae which makes the microbes more susceptible to chlorination. If excess chlorine is available after the oxidation of the chloramines, the 254 nm radiation will accelerate the oxidation of bio-film or bacteria residue in the treated water. The UV clarifier is a relatively high maintenance item, because the quartz sleeve has to be cleaned regularly to prevent particulate build up on the sleeve which would block the UV radiation.

Conventional apparatus for sanitizing water using ozonation typically comprises a high efficiency ozone generator and a venturi mixer or inductor port that injects ozone gas into the water to oxidize contaminants in the water. Exemplary ozonation systems which have been found to be particularly effective in pools and spas are disclosed in Martin et al, U.S. Pat. No. 6,500,332, Martin et al, U.S. Pat. No. 6,129,850, Martin et al U.S. Pat. No. 6,372,148, Martin, U.S. Pat. No. 6,331,279, and Bertnik et al, U.S. Pat. No. 6,669,441. Other ozonation systems are disclosed in Karlson, U.S. Pat. No. 5,855,856, Morehead U.S. Pat. No. 5,451,318, Engelhard, U.S. Pat. No. 5,709,799, and Karlson et al., U.S. Pat. No. 5,518,698. The entire disclosure of each of these patents is incorporated herein by this reference.

Ozone has been recognized by the FDA to be more than 200 times stronger than chlorine in microbial kill, and can react at higher oxidation levels than can be achieved safely with chlorine. However, dissolved ozone can exist in water for only a very short period before it reacts and is converted back into oxygen gas. Thus, dissolved ozone is not an effective residual sanitizer, in contrast to chlorine which has relatively steady and consistent residual sanitation properties.

To overcome the short residence time of ozone and the high vapor pressure of chlorine in hot spa water, spa and pool owners have added at sodium bromide salt to the water. Bromine has a very low vapor pressure compared to chlorine, thus, it does not vaporize as readily in aerated hot spa water. Dissolved ozone or sodium hypochlorite will react with the bromide ion to create the hypobromite ion in the water. Hypobromous acid or sodium hypobromite salt will oxidize ammonia to nitrogen gas without creating an intermediate amine compound like the chlorine oxidizer.

Attempts to combine the favorable properties of chlorination and ozonation are described in Tamir, U.S. Pat. No. 4,804,478 and Gargas, U.S. Pat. Nos. 6,517,713 and 6,551,518. The entire disclosure of each of these patents are incorporated herein by this reference.

There still exists a need for water treatment systems having the superior sanitizing properties of ozonation systems and the consistent residual properties of electrolytic chlorine systems. Furthermore, there exists a need for such systems which can be manufactured simply and inexpensively, which can easily fit or be retrofitted into a conventional swimming pool, spa, cooling tower, water feature or the like, and which requires relatively little maintenance.

### SUMMARY OF THE INVENTION

Accordingly, new water treatment apparatus and methods are provided by the present invention. The apparatus are highly effective in sanitizing water in a pool, spa, fountain, cooling tower, or other reservoir of water and are designed to be effective in destroying harmful and disagreeable organic material in the water while making the water comfortable and safe for its intended purposes.

In one aspect of the invention, water treatment apparatus are provided which generally comprise an inlet line adapted to receive a flow of water to be treated, and an injector assembly, for example a venturi injector, connected to the inlet line and structured and adapted to combine the flow of water with an oxygen-containing gas, for example, air and/or an ozone containing gas. The first water having an increased level of oxygen relative to the stream of water, is then passed, preferably directly passed, to an electrolytic device, which may include a bipolar cell positioned in contact with the first water, and stream of ozonated water and effective to combine a biocidally active substance with the first water to produce a second water, for example water containing a halogen-containing component, such as chlorine, a chlorine-containing component, bromine, a bromine-containing component and the like, ozone, other oxidants, and the like and mixtures thereof.

Although the electrolytic device is sometimes hereinafter referred to as an “electrolytic chlorinator”, it should be appreciated that the present invention is not intended to be limited to a conventional electrolytic chlorinator but may be any suitable electrolytic device useful for the purposes and objects of the invention described elsewhere herein. Preferably, the water stream in the inlet line includes a salt, such as a halide salt, for example, an alkali metal halide salt, such as sodium chloride sodium bromide and the like and mixtures thereof.

An outlet line may be provided which is adapted to pass the second water from the electrolytic device to an application for use, for example to a pool, such as a swimming pool and the like, spa, hot tub, fountain, cooling tower, other reservoir and the like.

The apparatus are preferably structured to be easily installed into an existing circulation system for the reservoir. Water may be cycled through the apparatus by means of a pump mechanism, located, for example, upstream of the ozone injector.

In a preferred embodiment, an ozone generator is provided and is coupled to the injector to be effective to introduce, for example, inject, an ozone containing gas into the stream of water such that the first water comprises a first ozonated water and the second water comprises a second ozonated water.

Preferably, the apparatus further include a control system effective to regulate a quality or property of the water passing through the apparatus. For example, the control system may include one or more sensors and a control unit, for example a microprocessor based control unit, configured to respond to an input signal from the one or more sensors, for example, electronic sensors, and to regulate power output to the electrolytic chlorinator, the ozone generator and/or pump in order to maintain or adjust the quality or property of the first or second ozonated water, for example, water being passed out of the apparatus and into the reservoir.

In some embodiments of the invention, two or more of the components of the system are contained in a common housing. For example, in some embodiments, the ozone generator and the power supply for the electrolytic chlorinator, or the ozone generator and the electrolyte chlorinator with or without the power supply are contained within a common housing. In other embodiments, the injector assembly and the electrolytic device are contained within a common housing. In a particularly advantageous embodiment, the injector assembly and the electrolytic device are located so as to treat or process water in a main water line of an existing circulation system for the reservoir or the like.

In more specific aspects of the invention, the control system may comprise a flow sensor for detecting flow and shutting off power to one or more of the components of the system in the event that a low flow threshold is detected by the sensor.

In some embodiments, the control system includes a pH controller configured to maintain both a desired pH level in the first ozonated water and/or a desired pH level in the second ozonated water. Advantageously, the apparatus may be structured such that the pH of the water passing to the electrolytic device is sufficiently acidic to provide an acid wash, for example, a substantially continuous acid wash, or at least a partially continuous acid wash, to the electrolytic device. For example, in some embodiments of the invention, the water passing to the electrolytic device provides an acid wash, for example, a continuous acid wash to the electrolytic cell plates.

For example, in some embodiments, the pH controller structured to be effective to add an agent, for example, hydrochloric acid and/or carbon dioxide gas, to water upstream of the electrolytic device, said agent being effective to provide an acidic wash to the electrolytic cell plates to substantially prevent or at least reduce the buildup of particulate material, for example, calcium carbonate scale, thereon.

For example, the apparatus may include a mechanism structured to pass the pH adjusting agent from an external storage tank into the stream of water entering the injector or into the first ozonated water. In one advantageous embodiment, the pH adjusting agent is drawn substantially directly into the injector assembly, for example, along with the ozone containing gas from the ozone generator. The pH adjusting agent may be released into the water stream at intermittent times, continuously, and/or specifically in response to a signal from the control unit.

In some embodiments, the control unit, upon receiving input from one or more sensors disposed in the water line, is programmed to adjust or vary the amount of power being supplied to the electrolytic device as needed to maintain a desired quality of water passed therefrom. In some embodiments, the control unit is capable of turning power to the electrolytic cell on and off in response to signals received from the sensor or sensors. By varying power supplied to the electrolytic cell, the quality, for example, the oxidation reduction potential, of water downstream of the cell can be modified.

In a particularly advantageous embodiment, the control system includes a water quality sensor, for example, an oxidation-reduction potential (ORP) sensor. The control system may be structured so that the ORP level in the water passed from the electrolytic chlorinator is maintained at between about 600 mV and about 650 mV.

In some embodiments of the invention, the apparatus includes both a pH probe and an ORP sensor positioned, for example, to be in contact with water in the inlet line passing to the ozone generator. In such embodiments, the control system is preferably structured and configured to control and maintain appropriate ORP level and pH level based on input received from the sensors.

Advantageously, in accordance with the invention, the control system may be set to accommodate human users of the reservoir, for example, bathers, swimmers and the like, with specific needs. For example, for enhancing the comfort of bathers with very dry skin, the ORP may be set to about 600 mV and the pH controller set to about 7.2.

In another aspect of the invention, the control system may be structured to be effective to control alkalinity of water passing to the electrolytic device, and may include means for adding a substance to the water for regulating the alkalinity thereof.

For hard water sources for water features, the hardness is intentionally precipitated on the current cathode side of the electrolytic chlorinator cell. Carbon dioxide or bicarbonate salt can be added to maintain alkalinity above 100 ppm but less than 200 ppm to encourage precipitation calcium or magnesium or other carbonate salts on the cathode side of the plate. Carbon dioxide can also be used the control the pH of the water. The advantage of carbonate salt precipitation is apparent during a current reversal cycle. When carbonate salt is converted to carbon dioxide gas and dissolved salt, gas pressure builds below the carbonate salt layer, which in turn causes mechanical failure of the layer adhesion, which in turn causes flakes of precipitated carbonated salt to be carried down stream by the flowing water.

In one embodiment, alkalinity in the water is maintained between about 100 and about 200 ppm to encourage precipitation of hardness as a carbonate salt, thus reducing the total hardness in the body of water.

For example, the apparatus can be configured such that a sulfate salt can be added, for example, automatically, to the water on a regular or as needed basis in order to encourage precipitation of hardness as a sulfate salt, thus reducing the total hardness below about 150 ppm in the body of water.

In an advantageous embodiment, a collector is located downstream of the electrolytic chlorinator which serves to collect precipitate, for example, flakes of precipitated carbonate salt. The collector may comprise a dead space in the flow line located between the electrolytic chlorinator outlet and the inlet to the pool or other reservoir. An exhaust port may be provided for enabling removal of ejection of the precipitate collected in the collector.

When the water hardness must be maintained below about 150 ppm to prevent scale build up due to evaporation on natural or manmade stones or other porous solids, about 8 to about 40 ppm of sodium or potassium sulfate salt can be added, to the water for example, automatically added to the water by means of the control system, in order to encourage precipitation of calcium or magnesium sulfate salt on the cathode side of the electrode. The sulfate ion changes the water solubility of the hardness so that it will precipitate at pH greater than about 7.0-about 7.6. This sulfate salt addition can drop the hardness to below about 50 ppm, to make clear water for fountains and maintain the beauty of the fountain or other water feature, by preventing unsightly tan or white scale buildup in areas of high evaporation. When hardness is dropped below about 120 ppm, care must be used to prevent leaching the calcium carbonate from any mortar exposed to the water. When dust or rain storms blow lots of lawn debris or dirt into the water feature, potassium peroxymonosulfate can be added, for example, automatically, and used as a shock and as a salt to remove the hardness addition from the dissolved dirt.

Preferably, the apparatus is structured such that chlorine is generated on the anode of the electrolytic chlorinator while other oxidants are generated from a combination of ozone or molecular oxygen and hydrogen on the cathode. For average flow velocities, low current densities, and injection of ozone containing gas from the ozone generator having an ozone concentration less than about 100 ppm, the bi-polar cathode mostly produces the hydroxyl radical (OH) which immediately reacts with any organic compound or chloramines in the stream. For average flow velocities, low current densities, and air injection with ozone concentrations greater than about 100 ppm, a high ozone concentration will be left in the bubbles and the cathode generated hydrogen will make both hydroxyl radical (OH) and the hydroperoxyl radical (HO2). The hydroperoxyl radical can react with water (H2O) to form the hydroxyl radical (OH) and hydrogen peroxide (H2O2). For high concentrations of ozone-containing gas passed into the electrolytic chlorination cell, a high ozone concentration residual will be left in the bubbles, and the cathode generated hydrogen will make both hydroxyl radical (OH) and the hydroperoxyl radical (HO2) and some trace chlorine dioxide (ClO2) generated on the anode at high current densities. Some of the ozone also reacts with the water to make hydrogen peroxide (H2O2).

In some embodiments of the invention, the control system is configured and structured to control the ozone generator.

For example, in use in a swimming pool, the control system can be used to create a water stream passing from the pool into the apparatus to achieve a high ozone concentration in order to cause rapid oxidation of organic loading. As the ORP reading approaches a set point, ozone concentration can be reduced to maximize chlorine residual in the water at a set point turn off.

Preferably, the ozone injector and the electrolytic chlorinator are coupled in a manner effective to substantially increase or enhance the amount and/or concentration of mixed oxidants, for example, hydroxyl radicals, produced by the electrolytic chlorinator. For example, the ozone injector and the electrolytic chlorinator are directly coupled together so that the first ozonated water flows directly from the injector assembly into the electrolytic device. For example, a conduit or other duct providing fluid communication between the ozone injector and the electrolytic chlorinator includes no effective degassing structure, effective mixing structure, and/or effective mixing and degassing structure located therealong. The apparatus is preferably structured such that the stream of ozonated water is maintained in an aerated, for example, oxygenated, state when the stream enters the electrolytic device, thereby causing the electrolytic device to produce a useful stream of water having ozone and other oxidants, for example, hydroxyl radicals.

The apparatus is advantageously adapted for use in a water reservoir such as a pool, spa, cooling tower or the like having a circulation system, wherein the circulation system includes a main conduit communicating with the reservoir and a pump for circulating water through the main conduit and into and out from the reservoir.

In some embodiments of the invention, the apparatus is disposed in a bypass line or a side stream allowing the apparatus to run independently of, or in conjunction with the reservoir circulation system.

In other embodiments, one or more components of the apparatus, for example, the electrolytic device and the ozone injector assembly, are mounted substantially in-line with the main conduit of the circulation system. Advantageously, both of these components of the system may be enclosed in a common housing structured to be connectable to a main water line of an existing circulation system.

In some embodiments, the inlet line of the apparatus may be coupled to a secondary supply conduit leading from the main conduit of the circulation system. A secondary pump, within the housing and positioned near the inlet opening, draws water through the secondary supply conduit, passing the water into a water inlet port of an ozone injector. Ozonated and aerated water then exits through an ozonated water outlet of the ozone injector and passes into an inlet of an electrolytic chlorinator located downstream of the ozone injector. The water, now containing mixed oxidants such as chlorine, bromine, ozone, hydroxyl radicals and the like, exits through the outlet of the electrolytic chlorinator and continues through the outlet of the housing, which is coupled to a secondary return conduit leading back to the main conduit of the circulation system.

Preferably the ozone injector is connected substantially directly to the electrolytic chlorinator, for example, by a single conduit or duct. Even more specifically, in one advantageous embodiment of the invention, the apparatus includes no separate mixing and or/mixing degassing vessel located between the ozone injector outlet and the electrolytic chlorinator. In this advantageous embodiment, greater amounts and/or varieties of hydroxyl radicals are produced in the water stream, thereby providing a greater range of microbial elimination.

In another aspect of the invention, the apparatus includes no separate mixing and or/mixing degassing vessel, or contact chamber, located downstream of the ozone injector and upstream of the electrolyte device.

A method of treating water in a reservoir according to the present invention comprises the steps of withdrawing a stream of water, for example, a stream of water containing a halogen-containing salt, such as sodium chloride, from the reservoir; injecting ozone into the stream of water; introducing the ozonated stream of water into an electrolytic chlorinator, for example, having a variable power supply; returning the ozonated and chlorinated stream of water to the reservoir; monitoring the quality of the water in the reservoir; and varying the power supplied to the electrolytic chlorinator as needed to maintain the water quality at a desired level. Advantageously, the step of monitoring the quality of the water comprises monitoring a property, for example substantially continuously and automatically monitoring a property, for instance the ORP, of the water, using an electronic sensor. The output of the sensor is transmitted to an electronic controller that automatically varies the power supplied to the electrolytic chlorinator as needed.

In one embodiment of the method, wherein the reservoir includes a circulation system, the circulation system including a main conduit communicating with the reservoir and a primary pump for drawing water through the main conduit, the steps of injecting ozone into the stream of water and introducing the ozonated stream of water into the electrolytic chlorinator occur within the main conduit.

In an alternate embodiment, the step of withdrawing a stream of water from the reservoir comprises diverting a stream of water out of the main conduit and into a secondary circulation system, and the steps of injecting ozone into the stream of water and introducing the ozonated stream of water into the electrolytic chlorinator occur within the secondary circulation system. In this embodiment, the secondary circulation system includes a secondary pump independently operable of the primary pump. This allows the water treatment process to be performed substantially continuously, even when the primary pump is not operating.

The ozone enhanced electro-chlorination systems and methods of the present invention possess numerous advantages over prior art systems and methods using electrolytic chlorination alone.

First, mixed oxidants which have a broader killing range than straight chlorine are created in the electro-chemical cell. On the cathode surface, atomic hydrogen (H) combines with molecular ozone (O3) to form the hydroxyl radical (OH) and molecular oxygen (O2). The molecular oxygen from the ozonated air can also combine with atomic hydrogen to form the hydroperoxyl radical (HO2). Both radicals can oxidize bio-film and other organic particles or compounds suspended in the water or combine with water molecule to make the hydrogen peroxide molecule (H2O2), which is a long half-life sanitizer like chlorine.

With the increased pulsed current density provided by the electrolytic chlorinator and dissolved ozone, hydrochloric acid (HCl), hypochlorous acid (HClO) and very tiny percentage chlorite acid (HClO2) can form on the anode surface. Typical oxide coatings on pool, cooling tower and spa cells are optimized for the production of chlorine with a small production of oxygen for chloride salt concentrations approaching 2000 ppm. With doped diamond-like or iridium oxide coatings on the anode, the electro-chemical cell operation can be extended to the salt content of fresh water. Field experience shows that a voltage pulse is needed to push current across the plate gap while preventing an arc formation when organic matter bridges the gap. As the salt content of the water approaches 400 ppm, a tiny amount of ozone and chlorine dioxide can be produced along with the molecular oxygen on the anode surface to increase the broadband microbial killing ability of the mixed oxidants produced with ozone enhanced electro-chlorination system. With the increased current density of the voltage pulse, the current density can rise between the plates to deliver lethal dose of electrical current to the bacteria or algae cell.

In addition, water treated according to the apparatus and/or method of the present invention is more sanitary due to the generation of mixed oxidants than water treated by electrolytic chlorination alone, and it will contain a lower residual chlorine level at an equivalent ORP meter reading.

For instance, because the bulk of the oxidation and sanitizing is performed by ozonation and mixed oxidants, the system requires a smaller electrolytic and ozone cells than systems using only electrolytic chlorination or ozone with a salt, for example, a sodium chloride salt or a bromide salt. Accordingly, the total cost of the ozone enhanced electro-chlorination system can be reduced.

The addition of ozone upstream to the electrolytic cell also inhibits scale formation in the electrolytic cell. Ozonated air bubbles act like a micro-flocculent attracting tiny particles of calcium carbonate scale, thus keeping the cathode surface reasonably clean even if the calcium ion concentration rises above about 240 ppm in the water. The bubble flow helps remove the flakes of calcium carbonate after a reverse in cell polarity. Another advantage of the ozone addition is that the organic matter that normally combines with the calcium carbonate build up on the cathode is removed by oxidation. This could eliminate the need for the expensive electronic “self-cleaning cycle” that is required by most bipolar electrolytic chlorination systems, but field experience shows that “self-cleaning cycle” may still be useful but the delay time can be extended by a factor about 4 to about 8. Thus, by adding ozonated air and reversing the polarity occasionally on the electrolytic cell, the system can become ‘maintenance free’ for the whole swimming season of the pool. For cooling towers and aquatic animal habitats, the present invention greatly reduces the amount and/or frequency of clean up, for example, during the yearly maintenance cycle.

The polarity reversal during the “self-cleaning cycle” is destructive to the electrolytic cells themselves, damaging the precious metal oxide coatings by reducing a tiny amount of oxide to the precious base metal when the anode surface is switch to the cathode surface. For higher current densities, titanium hydride is created at the coating interface. When the polarity is switched again, the acid created on the new anode surface dissolves the precious base metal until it reaches a new layer of precious metal oxide, thus shortening the life expectancy of the cells. For higher current densities, the titanium hydride is converted to titanium oxide and water vapor which delaminates the oxide coating. The use of the present systems can prevent or greatly reduce the reduction of the oxide coating to base metal by absorbing most of the atomic hydrogen to create hydroxyl radicals, extending the cell life, and reducing costs associated with replacement parts.

Furthermore, ozone oxidizes the urea and ammonia based substances that would otherwise react with chlorine to form chloramines. Ozone also oxidizes organic matter that would other react down to the chain termination of chlorinated methane. Accordingly, fewer chloramines or chlorinated methanes are formed. Those that are formed are destroyed by the ozone. Ozone can also oxidize chlorinated hydrocarbons such as methyl chloride, methylene chloride and chloroform which are stable intermediate oxidation products of chlorine-organic matter reactions. Thus, the need for periodic superchlorination is reduced or eliminated.

Moreover, ozonation of suspended organic particles imparts surface charges to the molecules, causing them to stick together, thus becoming more filterable. This process, know as “micro-flocculation”, allows ozone to provide clearer water than is possible with chlorine alone. In fact, for water features such as fountains, the water droplets can temporarily bead on the surface, due to the increased surface tension of the clean water, creating a wonderful visual effect for sunlight and artificial night light.

For the commercial spas, pool-spa combinations, or water features such as spraying fountains or cooling towers, the addition of sodium bromide to the water stream entering the apparatus can reduce the evaporation rate of chlorine from the main body of water. Chlorine or ozone can oxidize the bromide ion to bromine. The hypobromite ion does not decompose like hypochlorite ion when exposed to the ultraviolet light spectrum from the sun or low-pressure mercury lamp, thus bromine sanitizer has a longer half-life in the water.

Both chlorine evaporation and oxidation of the organic compounds cause the pH of the water to rise over time, which in turn requires the addition of hydrochloric acid to prevent the precipitation of calcium salts. Calcium carbonate or calcium sulfate usually will precipitate when the pH rises above about 7.9 on the edges where the water splashes against wall or surface of a water feature. The precipitated calcium salts leave ugly white and tan splotches on the surface which has to be removed with scrubbing using a lime removing product. Hydrochloric acid is used to replace the chlorine that evaporated from the water or to combine with the calcium ion to keep it soluble in the water.

The pH controller may be set to maintain the pH of the water in the reservoir at between about 7.1 to about 7.4 while an acid component, for example, hydrochloric acid, is added to the water stream upstream of the electrolytic cell in an amount effective to maintain concentration of the chloride ion in the water at surfaces of the electrolytic cell plates to provide an acid washed on a regular basis. The present ozone enhanced electro-chlorination system can be structured to be substantially ‘maintenance free’ during most of the swimming season. The pH controller is set to not let the pH drop below about 6.5 down stream of the electrolytic cell to prevent leaching or oxidation of metal pump parts or heat exchangers surfaces.

Experience shows if the pH drops below about 6.5, copper or stainless steel heat exchangers will dissolve and precipitate on the pool or spa surface changing the color to a light blue-green or light brown-gray respectively. Cooling towers electrolytic cells usually require additional acid washing to remove harden scale buildup.

In addition, the control system included with the ozone enhanced electro-chlorination systems of the present invention allows treatment of the water to adjust input of chemicals and/or the amount of electrolytically generated chlorine containing agents, as desirable or necessary in response to changing conditions, substantially without need for user intervention. If the acid reservoir or carbon dioxide cylinder is large enough, pH and ORP controller can prevail over water and organic material additions after a rain, dust or wind storm. The immediate treatment of contamination prevents the introduction of resistant strains of black algae and leaf mold growth in porous surfaces of the tile grout, cement, or plaster of the pool, spa, and fountain or on evaporation enhancers in the cooling tower.

For aquatic animal habitats in the zoo, after the animal feeds or defecates in the water, the ORP meter will detect the organic matter addition to the water. The filter system will strain the large particles from the water while the ozone enhanced electro-chlorination system will oxidize the fine fiber particles, bacteria and yeast bodies, and gastric enzymes. The pH controller will then corrected the pH with acid to neutralize the ash left over from the oxidation of organic matter. A small amount of sodium or potassium sulfate salt can be added to the water to encourage the precipitation of the ash in the electro-chemical cell which is removed downstream.

Furthermore, the simple, compact design of the apparatus of the present invention allows for simple, low-cost manufacture of the apparatus, and for easy installation in a pre-existing water circulation system.

Any feature or combination of features described herein is included within the scope of the present invention provided that the features of any such combination are not mutually inconsistent.

Additional aspects and advantages of the present invention are set forth in the following description and claims, particularly when considered in conjunction with the accompanying drawings in which like parts bear like reference numerals.

### BRIEF DESCRIPTION OF THE DRAWINGS

FIG. 1 is a schematic diagram showing a water treatment apparatus according to the present invention; and

FIG. 2 is a schematic diagram showing a water treatment apparatus according to another embodiment of the invention; and

FIG. 2a is a schematic diagram showing a water treatment apparatus according to a further embodiment of the invention.

FIG. 2b is a schematic diagram showing yet a further embodiment of the invention.

FIG. 2C is a schematic diagram showing another water treatment apparatus in accordance with the invention.

FIG. 3 is a flow chart showing a method of water treatment according to the present invention.

### DETAILED DESCRIPTION

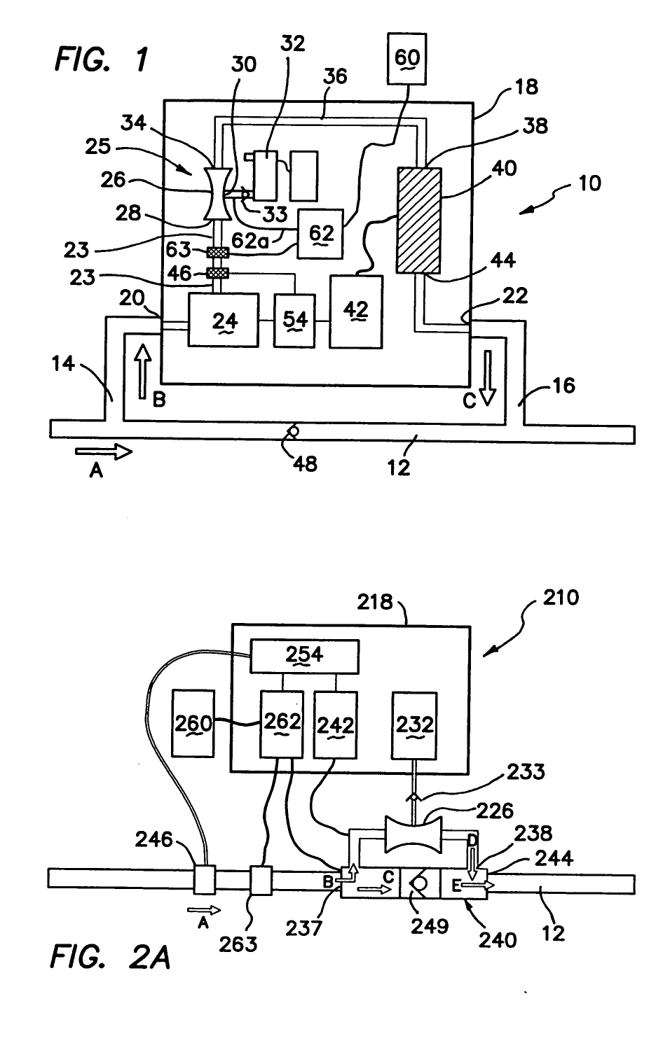

Referring now to FIG. 1, a water treatment apparatus in accordance with the present invention, adapted for use in a water reservoir, such as a swimming pool, pond, aquatic mammal tank, spa, fountain, or the like, is shown generally at 10.

Advantageously, water is circulated through the reservoir by a circulation system including a main conduit 12 and a primary pump (not shown). In the embodiment of the invention shown, a secondary circulation system, or side stream, including a secondary supply conduit 14 and a secondary return conduit 16, is providing for diverting at least a portion of a stream of water, initially traveling in the direction shown by arrow A, from the main conduit 12 through the water treatment apparatus 10, in the direction shown by arrow B, and subsequently returning the treated water back to the main conduit in the direction shown by arrow C. A check valve, 48 may be used to prevent backflow of treated water from conduit 16 to conduit 14.

The apparatus 10 generally includes a housing 18 having an inlet opening 20 coupled to the secondary supply conduit 14 and an outlet opening 22 coupled to the secondary return conduit 16. An inlet line 23 passes a water stream from inlet opening 20 through a secondary pump 24, which draws water through the apparatus 10. The water stream passed to the pump preferably includes an effective amount of a salt, for example an alkali metal halide salt, such as sodium chloride, sodium bromide and the like and mixtures thereof.

Downstream of the pump 24, is an injector assembly 25 comprising a venturi injector 26 having a water inlet port 28 for receiving water ejected from the pump 24, an inlet 30 for receiving a gas, for example, an oxygen containing and/or ozone containing gas. The apparatus 10 may further include an ozone generator 32 for producing ozone, and a check valve 33 to prevent back flow of water into the ozone generator, and an ozonated water outlet 34 which releases a stream of water containing ozone and/or being substantially aerated, into a duct 36 connected to an inlet end 38 of an electrolytic chlorinator 40.

In a preferred embodiment, the electrolytic chlorinator 40 comprises a bipolar cell, for example, a bipolar chlorine salt cell. The electrolytic chlorinator 40, is connected to an energy source 42, preferably a variable power supply 42. After the water passes through the electrolytic chlorinator 40, the water contains chlorine, mixed oxidants and ozone. This highly effective sanitizing stream then passes through outlet 44 which communicates with the housing outlet 22, allowing the treated water to be passed to the main supply conduit 12 via the secondary return conduit 16 and to an application for use, for example a pool, spa, fountain cooling tower or other reservoir requiring or benefited by sanitized water.

Preferably, the ozone injector 26 and the electrolytic chlorinator 40 are coupled in a manner effective to substantially increase or enhance the amount and/or concentration of mixed oxidants, for example, hydroxyl radicals, that are produced by the electrolytic chlorinator 40. For example, apparatus 10 is preferably structured such that the stream of ozonated water leaving the ozone injector 26 is maintained in an aerated state when the stream enters the electrolytic chlorinator 40. This will allow or cause the electrolytic chlorinator to produce a useful stream of water having ozone and other mixed oxidants that are useful in sanitizing a variety of microorganisms for example.

In a preferred embodiment, the ozone injector 26 is substantially directly connected, preferably by single duct 36, to the electrolytic chlorinator 40. In this embodiment, the apparatus 10 preferably includes no mixing vessel or contact chamber effective to contain and mix ozonated water passed to the electrolytic chlorinator 40. It has been found that by directly connecting the ozone injector and electrolytic chlorinator as shown, and providing a substantially continuous flow of aerated water into the electrolytic chlorinator during operation of apparatus 10, the apparatus 10 will produce a variety of hydroxyl radicals that would not be produced if the water was degassed prior to entering the electrolytic chlorinator 40, for example, if the water was first passed through a mixing chamber, degassing chamber, contact chamber or the like prior to entering the electrolytic chlorinator 40.

The ozone generator 32, ozone injector 26, and electrolytic chlorinator 40 may be of any suitable type known in the art. For instance, the components of the ozone generator 32 and ozone injector 26 may be similar in structure and function to those disclosed in Martin, U.S. Pat. No. 6,500,332, the entire disclosure of which is incorporated herein by this specific reference. The electrolytic chlorinator 40 may be similar to any of those disclosed in Kosarek, U.S. Pat. No. 4,361,471, Wreath, et al., U.S. Pat. No. 4,613,415, and Lynn, et al., U.S. Pat. No. 5,362,368, the entire disclosure of each of which being incorporated herein by this specific reference.

Preferably, electrolytic chlorinator 40 is substantially smaller, for example, about 25% smaller, than prior art electrolytic chlorinators. For example, in one particularly advantageous embodiment, the pump 24 is a relatively small, for example 1/15 horsepower, pump. The size and low power requirements of this embodiment allow the apparatus to be economically operated on a substantially continuous basis, or for an extended period of time, thereby providing long term, continuous water treatment of water in a pool, spa, fountain or other water feature.

The small size of the electrolytic chlorinator 40, which is made possible by the fact that much oxidizing and sanitizing activity is performed by ozone as well as mixed oxidants, is particularly advantageous in that all of, or substantially all of, the components of the apparatus 10 to be packaged in a small, compact housing 18 that can conveniently be mounted by the side of the pool, spa, fountain or other water feature.

In a preferred embodiment, the apparatus 10 further comprises a control system, including a sensor 46 and a control unit 54. The sensor 46 may comprise any suitable sensor, preferably a quality electronic sensor, effective to monitor and/or measure a property of water in contact therewith. The control unit 54 may comprise a microprocessor based control unit effective to regulate a property of the water passing through the apparatus based on a signal received from the sensor 46. For example, the control unit 54 may be operatively coupled to a component, for example, the electrolytic chlorinator power supply 42, the ozone generator 32, and/or the pump 24, and may be responsive to regulate the component in response to an input signal from sensor 46.

For example, the sensor 46 may comprise a flow sensor mounted upstream of the ozone injector 26. The control unit 54 may be configured to shut off or regulate power to the pump 24, ozone generator 32 and/or electrolytic chlorinator power supply 42 when the sensor 46 indicates that flow has dropped below a predetermined level.

The apparatus 10 may further comprise a pH controller 62, configured to maintain a desired pH level in the water flowing through the apparatus 10. For example, the pH controller 62 is configured and located to release carbon dioxide gas, hydrochloric acid or other suitable agent from a supply tank 60 into the receiving duct 30 of the ozone injector 26 by means of line 62a. The pH controller 62 may also include a pH sensor 63, and be structured to regulate the addition of acid, for example, for maintaining a comfortable effective pH of about 7.2 in the reservoir being treated and preventing the downstream pH from dropping below about 6.5. With pH above about 6.5, wetted metal parts downstream of the electrolytic chlorinator 40 are not subject to a destructive corrosion rate.

Advantageously, the pH controller 62 may be configured to be effective to create continuous acidic wash in the duct 36, the wash having a pH effective to reduce or eliminate scale buildup on the electrolytic cells of the chlorinator 40.

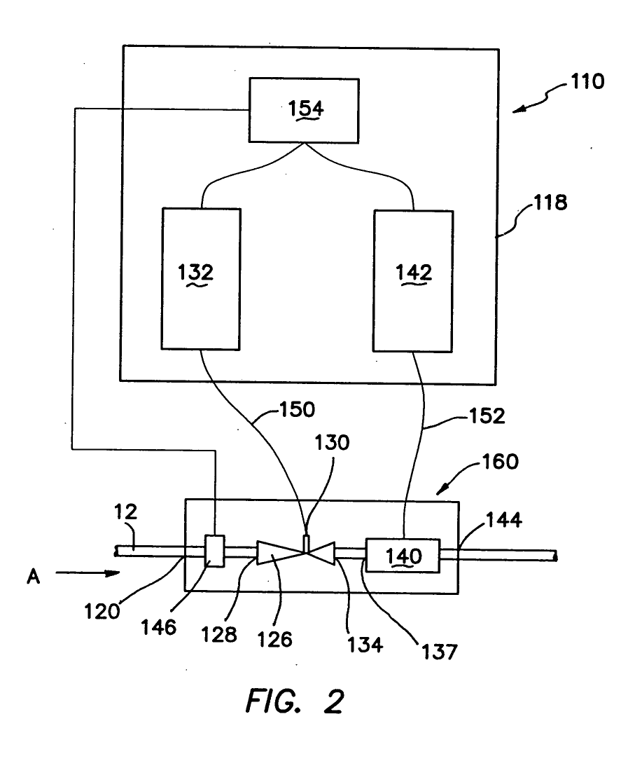

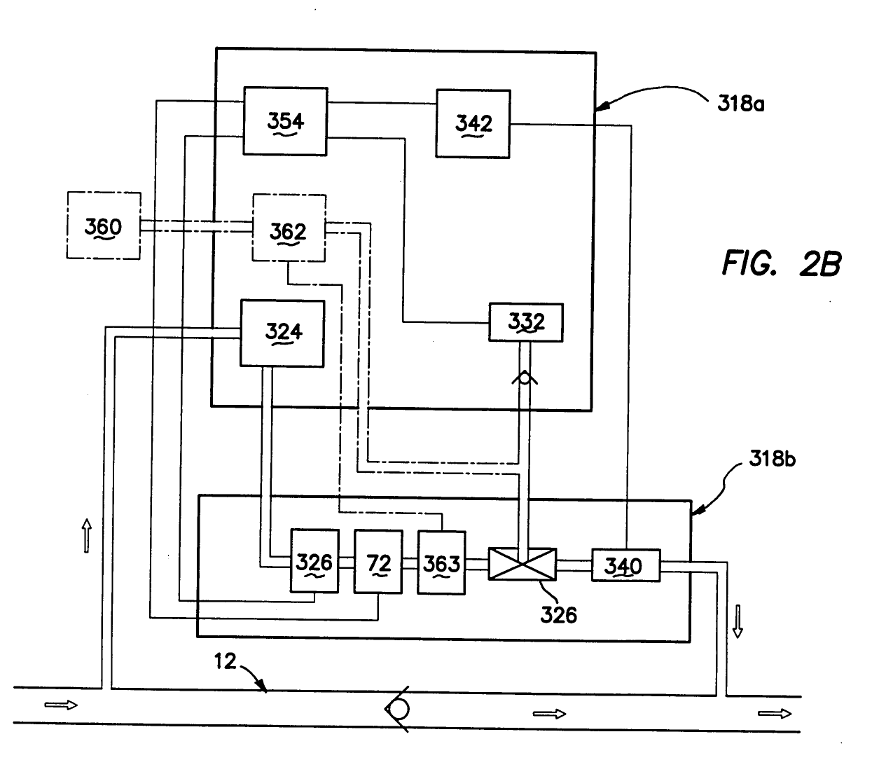

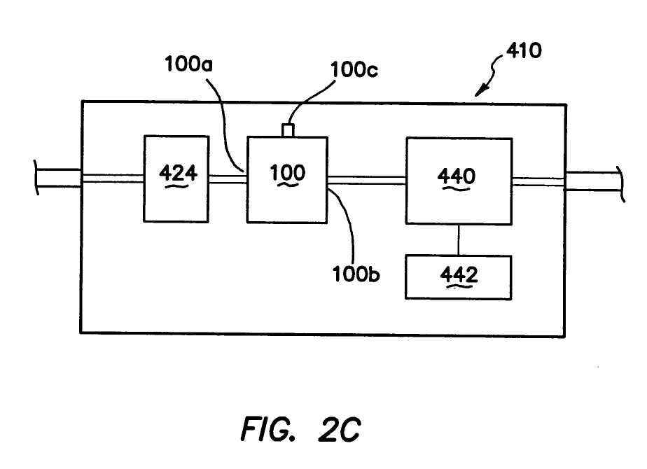

FIG. 2 shows another water treatment apparatus 110 in accordance with the present invention. Except as expressly described herein, apparatus 110 is similar to apparatus 10, and features of apparatus 110 which correspond to features of apparatus 10 are designated by the corresponding reference numerals increased by 100.

In this embodiment, the bypass lines have been eliminated, and an ozone injector 126 and an electrolytic chlorinator 140 are mounted directly in the main conduit 12 of the reservoir circulation system. Water, powered by a pump (not shown) in line 12, enters the injector housing 160 through inlet 120, and enters the ozone injector 126. Water passing through the ozone injector 126 enters the electrolytic chlorinator 140 via the ozonated water inlet 137. The ozonated and chlorinated water then exits the chlorinator through the ozonated and chlorinated water outlet 144, and continues toward the reservoir via the main conduit 12. As in the previous embodiment, a flow sensor 146 may be provided upstream of the ozone injector 126 for monitoring flow through the system and shutting off power to the electrolytic chlorinator when the flow drops below a predetermined level.

Ozone gas for the ozone injector 126 is supplied through an ozone duct 150 leading from an ozone generator, for example, a remotely located ozone generator 132. The ozone generator 132 preferably shares a common housing 118 with the electrolytic chlorinator's power supply 142, which is connected to the electrolytic chlorinator 140 by a waterproof cable 152.

The apparatus 110 preferably also includes a control unit 154 for example, contained within the housing 118, for controlling various aspects of the water treatment system. For instance, the control unit 154 is preferably coupled to both the flow sensor 146 and the power supply 142 of the electrolytic chlorinator 140, causing the chlorinator 140 to shut off automatically when the flow falls below a predetermined or safe level.

The control unit 154 may also be coupled to a water quality sensor for monitoring the quality of water in the reservoir. The control unit 154 may include a regulator for automatically varying power to the electrolytic chlorinator as needed to maintain the water quality at a desired level. The water quality sensor may, for instance, an ORP sensor for measuring the oxidizing activity of the water. Other sensors suitable for measuring or monitoring properties such as the pH or chlorine concentration of the water could also be used instead of, or in addition to, an ORP sensor.

FIG. 2a shows a further water treatment apparatus 210 in accordance with the present invention. Except as expressly described herein, system 210 is similar to apparatus 10, and features of apparatus 210 which correspond to features of system 10 are designated by the corresponding reference numerals increased by 200.

In this embodiment, an ozone injector 226 and an electrolytic chlorinator 240 are mounted in a bypass circuit 214 and 216 to the main conduit 212 of the reservoir circulation system with a bypass valve 249 controlling an amount of water diverted into the bypass circuit. Water passed through the ozone injector 226 enters the electrolytic chlorinator 240 via the ozonated water inlet 238. The ozonated and chlorinated water then exits the chlorinator 240 through the ozonated and chlorinated water outlet 244, and continues toward the reservoir via the main conduit 12. As in the previous embodiment, a flow sensor 246, connected to the control unit 254 may be provided upstream of the ozone injector 226.

Ozone gas for the ozone injector 226 is supplied by a remotely located ozone generator 232. Check valve 233 is preferably provided for preventing water or acid backing up into the ozone generator 232. The ozone generator 232 preferably shares a common housing 218 with the variable power supply 242 of the electrolytic chlorinator 240, which is connected to the electrolytic chlorinator 240 by a waterproof cable. An optional pH controller 260 may also be included.

The apparatus 210 preferably also includes a control unit 254 for example, contained within the housing 218, for controlling various aspects of the water treatment system. For instance, the control unit 254 is preferably coupled to both the flow sensor 246 and the electrolytic chlorinator's power supply 242, causing the chlorinator 240 to shut off automatically when the flow falls below a safe level.

A preferred embodiment of the invention is shown in FIG. 2b, generally at 310. Except as expressly described herein, apparatus 310 is similar to apparatus 10 and features of apparatus 310 which correspond to features of apparatus 10 are designated by the corresponding reference numerals increased by 300.

A primary difference between apparatus 310 and the previously described and shown embodiments of the invention is that, in apparatus 310, a first housing 318a is provided which encloses a control unit 354, electrolytic chlorinator power supply 342, ozone generator 332, a pump 324, preferably a 1/15 hp pump, and an optional pH probe. A secondary housing 318b contains flow sensor 346, optional pH sensor 363, venturi injector 326 and electrolytic chlorinator 340. As shown, an optional pH controller 362, and pH controlling agent supply tank 360 may also be included.

FIG. 2b also shows another advantageous feature of the invention. The control system may include a water quality sensor 72 for monitoring the oxidizing potential of water in the reservoir. For example, the control unit 354 may include a regulator for automatically varying power to the electrolytic chlorinator 340 by means of the variable power supply 342 and/or to the ozone generator 332 as needed to maintain the water quality at a desired level.

Preferably, the water quality sensor 72 is a sensor effective to measure the oxidation-reduction potential (ORP) of water passing into ozone injector 326, in order to enable control unit 254 to regulate or control operation of the ozone generator 332 and/or the electrolytic chlorinator 340.

The apparatus 310 is structured such that chlorine is generated on the anode of the electrolytic chlorinator while other oxidants are generated from a combination of ozone or molecular oxygen and hydrogen on the cathode. For average flow velocities, low current densities, and injection of ozone containing gas from the ozone generator having an ozone concentration less than 100 ppm, the bi-polar cathode mostly produces the hydroxyl radical (OH) which immediately reacts with any organic compound or chloramines in the stream. For average flow velocities, low current densities, and air injection with ozone concentrations greater than 100 ppm, a high ozone concentration will be left in the bubbles and the cathode generated hydrogen will make both hydroxyl radical (OH) and the hydroperoxyl radical (HO2). The hydroperoxyl radical can react with water (H2O) to form the hydroxyl radical (OH) and hydrogen peroxide (H2O2). For high concentrations of ozone-containing gas passed into the electrolytic chlorination cell, a high ozone concentration residual will be left in the bubbles, and the cathode generated hydrogen will make both hydroxyl radical (OH) and the hydroperoxyl radical (HO2) and some trace chlorine dioxide (ClO2) generated on the anode at high current densities. Some of the ozone also reacts with the water to make hydrogen peroxide (H2O2).

For example, in use in a swimming pool, the control system can be used to create a water stream passing from the pool into the apparatus 310 to achieve a high ozone concentration in order to cause rapid oxidation of organic loading. As the ORP reading approaches a set point, ozone concentration can be reduced to maximize chlorine residual in the water at a set point turn off.

Another apparatus in accordance with the invention is shown in FIG. 2c, generally at 410. Apparatus 410 generally includes an inlet line 423, pump 424, oxygenator 100, and electrolytic device 440 powered by power supply 442, and outlet line 4.

Oxygenator 100 may comprise any suitable mechanism for introducing an oxygen containing gas into the water in inlet line 423 to produce an oxygen-containing aqueous stream in line 436 which is passed, as a water containing an increased oxygen concentration relative to the water in inlet line 423, to the electrolytic device 440. Preferably, the apparatus 410 is structured such that the oxygen-containing aqueous stream in line 436 is substantially prevented from releasing the oxygen for example, undissolved oxygen, from the aqueous stream when the stream is introduced into the electrolytic device 440.

For example, the oxygenator 100 may comprise an injector assembly effective to inject oxygen-containing gas, for example, air, into the flow of water. The oxygenator 100 may include a venture injector having a water inlet 100a, a water outlet 100b and a gas inlet 100c in communication with atmospheric air.

Advantageously, the apparatus 410 is structured to be highly effective in producing an aqueous mixture having an increased or enhanced biocidal activity, for example, relative to an identical apparatus without the inclusion of oxygenator 100. Without wishing to be limited by any particular theory of operation, it is believed that by oxygenating the water passed to the electrolytic chlorinator, and substantially maintaining the water in the oxygenated state while the water is introduced to the electrolytic device, the electrolytic activity in the water causes increased chemical reactions in the water that more effectively produce biocidally active materials or species, for example, higher concentrations of one or more oxidants, and/or more varieties of different oxidants, than are produced without the water being oxygenated and substantially maintained in the oxygenated state.

The addition of a salt, for example, a halite salt, for example, sodium chloride and/or sodium bromide, to the water in the apparatus, further enhances the production of biocidally active materials.

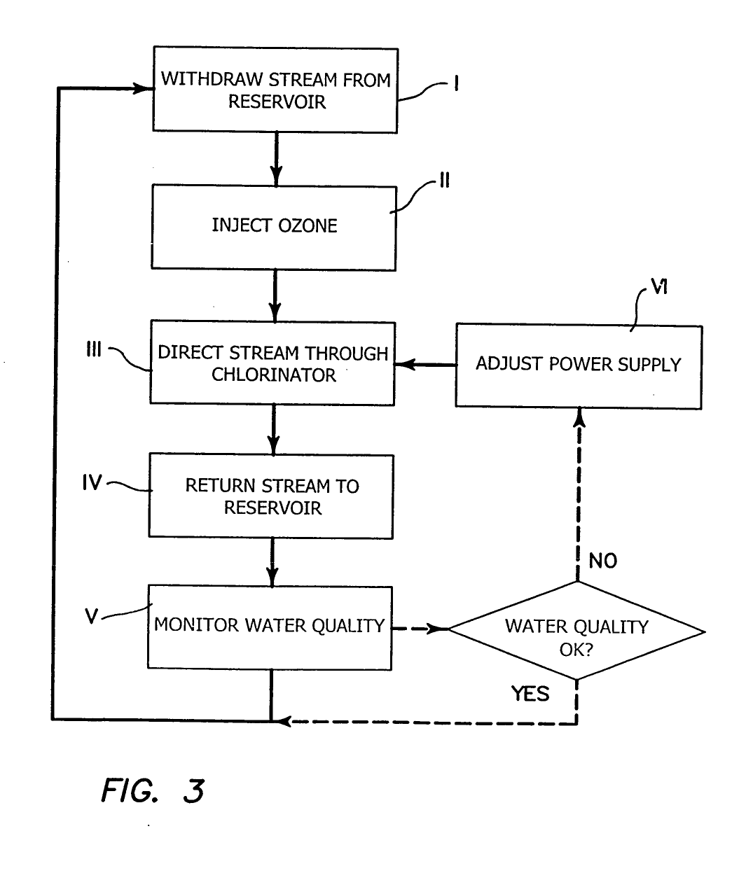

A flow chart outlining a method of water treatment according to the present invention is shown in FIG. 3. Briefly, the method comprises the steps of withdrawing a stream of water from a reservoir as shown in Block I, introducing, for example, injecting, ozone into the stream as shown in Block II, directing the first ozonated stream through an electrolytic device as shown in Block III, and returning the stream, now a second ozonated stream containing one or more biocidally active materials in addition to ozone, to the reservoir, as shown in Block IV. The quality of the water in the reservoir is preferably monitored continuously and automatically throughout the process, as shown in Block V, for example, by means of at least one of an ORP sensor and pH controller. When the quality of the water is found to fall below certain standards, a control signal from the sensor is sent to a control unit, which varies the amount of power supplied to the electrolytic device as needed to return the water quality to the desired level or allows injection of acid to adjust the pH back to the set point near neutral.

In some embodiments, the method includes utilizing an ozone injector to inject an acidic component or carbon dioxide gas into the water in an amount effective to produce an acidic wash in the first ozonated water and/or a super-chlorine level in the second ozonated water.

The steps of withdrawing the stream from the reservoir and returning the stream to the reservoir may consist of simply pumping the stream through the main conduit of the reservoir's preexisting circulation system, or they may comprise diverting the stream from the main conduit into a secondary circulation system communicating with the preexisting circulation system. In the former case, the steps of injecting ozone into the stream and directing the stream through the chlorinator or mix oxidant generator are performed within the main conduit itself. In the latter case, the steps of injecting ozone into the stream of water and introducing the ozonated stream of water into the electrolytic device occur within the secondary circulation system. The secondary circulation system including secondary pump, operates independently of the primary pump of the reservoir's circulation system, thus allowing 24 hour operation of the water treatment apparatus.

In other embodiments of the invention, a method is provided as described hereinabove with respect to FIG. 2c. For example, a method of the invention may comprise providing a stream of water containing a halide salt, introducing an oxygen-containing gas into the stream to form an oxygen-containing water stream, introducing the oxygen-containing water stream into an electrolytic device and producing an aqueous composition having at least one biocidally active substance other than oxygen. The aqueous composition can then be passed to an application for use as a sanitizer. The entire method, and any of the other methods in accordance with the invention, may be practiced using a substantially continuous flow of water throughout.

While this invention has been described with respect to various specific examples and embodiments, it is to be understood that the invention is not limited thereto and that it can be variously practiced within the scope of the following claims.

What is claimed is:

1. An apparatus for sanitizing water, the apparatus comprising:
an ozone generator structured to produce an ozone-containing gas;
an injector assembly structured and adapted to combine a flow of water and the ozone-containing gas to produce a first ozonated water;
an electrolytic device positioned to receive the first ozonated water and effective to combine a biocidally active substance and the first ozonated water to produce a second ozonated water;
a line adapted to pass the second ozonated water to an application for use; and
a control system including a sensor effective to monitor at least one property of the second ozonated water and a regulator configured to receive input from the sensor and to control at least one of the electrolytic device and the ozone generator in response to the sensor input.

2. The apparatus of claim 1 wherein the electrolytic device comprises an electrolytic cell.

3. The apparatus of claim 1 wherein the sensor is effective to monitor oxidation reduction potential of the second ozonated water.

4. The apparatus of claim 1 wherein the control system further comprises a pH controller.

5. The apparatus of claim 4 wherein the pH controller is configured to maintain a pH level in the first ozonated water that is effective to provide an acid wash to the electrolytic device.

6. The apparatus of claim 1 further comprising a mechanism structured to pass a pH adjusting agent into at least one of the first ozonated water and the second ozonated water.

7. The apparatus of claim 6 configured such that the pH adjusting agent is drawn substantially directly into the injector assembly.

8. The apparatus of claim 1 wherein the control system is further structured to be effective to control alkalinity of the first ozonated water.

9. The apparatus of claim 1 further comprising a collector positioned and effective to collect precipitates passing from the electrolytic device.

10. The apparatus of claim 1 wherein the control system includes a flow sensor.

11. The apparatus of claim 1 wherein the ozone injector and the electrolytic device are directly coupled together so that the first ozonated water flows directly from the injector assembly into the electrolytic device.

12. The apparatus of claim 1 wherein the injector assembly and the electrolytic device are structured to be installed to a circulation system for at least one of a pool, spa, cooling tower, fountain and water feature.

13. An apparatus for sanitizing water, the apparatus comprising:
an oxygenator structured to combine a flow of water with an oxygen-containing gas to produce an oxygen-containing water having an increased oxygen concentration relative to the flow of water;
an electrolytic device positioned to receive the oxygen-containing water and effective to produce an aqueous composition containing at least one biocidally active substance other than oxygen.

14. The apparatus of claim 13 which further comprises an outlet line adapted to pass the aqueous composition from the electrolytic device to an application for use.

15. The apparatus of claim 13 structured so that the aqueous composition has an enhanced biocidal activity relative to an identical apparatus without the oxygenator.

16. The apparatus of claim 13 further comprising a control system including
a sensor effective to monitor a property of at least one of the flow of water the oxygen-containing water and the aqueous composition, and
a regulator configured to control at least one of the electrolytic device and the oxygenator.

17. The apparatus of claim 13 further comprising a housing containing both the oxygenator and the electrolytic device.

18. A method of treating water comprising:
providing a stream of water containing a halogen-containing salt;
introducing an oxygen-containing gas into the stream of water to form an oxygen-containing water stream; and
introducing the oxygen-containing water stream into an electrolytic device and producing an aqueous composition having at least one biocidally active substance other than oxygen.

19. The method of claim 18 further comprising monitoring the circulating water and controlling the electrolytic device to maintain a desired biocidal activity of the aqueous composition.

20. The method of claim 18 wherein the step of introducing an oxygen-containing gas comprises introducing an ozone-containing gas, and the at least one biocidally active substance other than oxygen is a halogen-containing component.
